(19) United States
(12) Patent Application Publication
(10) Pub. No.: US 2016/0280118 A1
(43) Pub. Date: Sep. 29, 2016

(54) Construction Machine Transport

(71) Applicant: American Augers, Inc., West Salem, OH (US)

(72) Inventor: Timothy R. Plas, Elyria, OH (US)

(21) Appl. No.: 15/081,616

(22) Filed: Mar. 25, 2016

Related U.S. Application Data
(60) Provisional application No. 62/138,144, filed on Mar. 25, 2015.

(51) Int. Cl. B60P 3/06; B62D 55/32

(52) U.S. Cl. CPC B60P 3/062; B62D 55/32

(57) ABSTRACT

A system for towing a work machine. The system comprises a dolly assembly and a kingpin assembly. The kingpin assembly is pivotally attached to a first end of the work machine and connectible to a fifth wheel of a tow vehicle. The dolly assembly is attachable to the second end of the work machine The dolly assembly may raise and lower the work machine when attached. Shims secure the work machine off the ground to the kingpin assembly and the dolly assembly so that the work machine may be towed.

### CROSS REFERENCE TO RELATED APPLICATION

This application claims the benefit of provisional patent application Ser. No. 62/138,144 filed on Mar. 25, 2015, the entire contents of which are incorporated herein by reference.

### FIELD

This invention relates generally to transport systems for construction vehicles.

### SUMMARY

The present invention is directed to a system for towing a vehicle. The vehicle comprises a first end and a second end. The system comprises a kingpin disposed at the first end of the vehicle, a dolly disposed at the second end of the vehicle, and a hydraulic system for adjusting a height of the vehicle relative to the ground.

### BRIEF DESCRIPTION OF THE DRAWINGS

FIG. 1 is a side view of a system for transporting a construction vehicle.

FIG. 2 is a side view of the system of FIG. 1 wherein the undercarriage of the construction vehicle is removed.

FIG. 3 is a top view of the system of the system of FIG. 1.

FIG. 4 is a rear side isometric view of the system of FIG. 1.

FIG. 5 is a rear view of the system of FIG. 1.

### DETAILED DESCRIPTION

Transportation of large work machines often requires cranes for loading and unloading such machines onto a trailer, and the transportation of empty trailers to and from job sites. Therefore, there is a need for an apparatus that can transport these machines without using dedicated equipment just for the purpose of placing the work machine on a trailer.

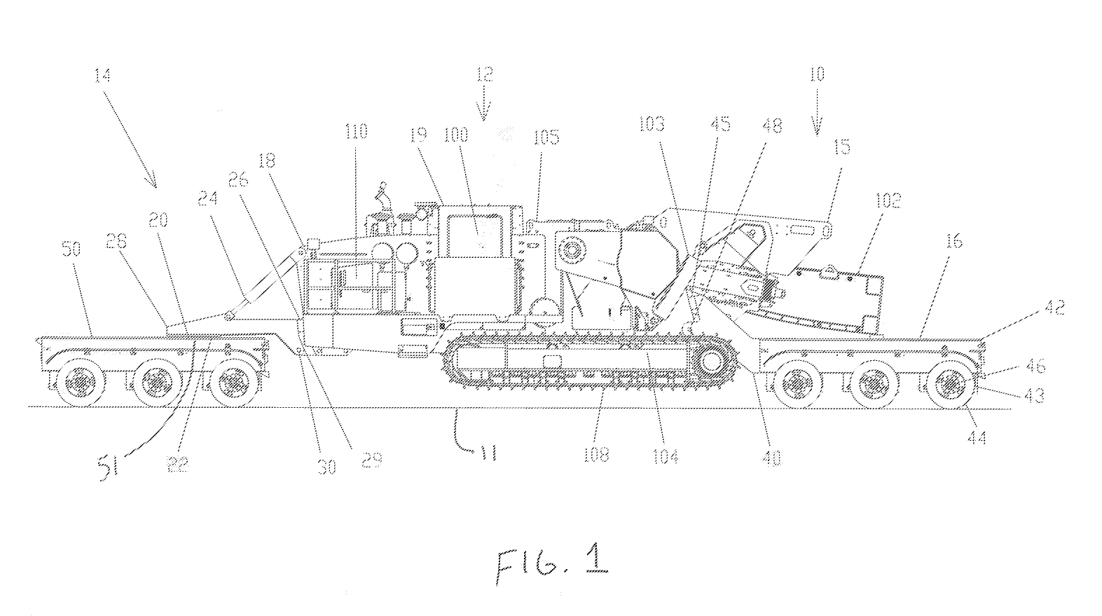

With reference to the Figures in general and FIG. 1 in particular, shown therein is a transport system 10 for transporting a work machine 12 such as a trencher. While a trencher is of particular interest and shown in FIG. 1, other large construction equipment, such as cranes, excavators, front-end loaders, bucket wheel trenchers, rock saws, surface miners, and others can be transported using the system 10 as well. The system 10 enables the work machine 12 to be hauled without the use of a trailer.

The system comprises a kingpin assembly 14 and a dolly assembly 16. The kingpin assembly 14 is located at a first end 18 of the work machine 12. The dolly assembly 16 is located at a second end 15 of the work machine 12, though the location of the dolly assembly relative to the kingpin assembly 14 on the work machine 12 may be reversed.

As shown in FIG. 1, the work machine 12 is a trencher comprising an operator station 100 positioned between the first end 18 and the second end 15, a pivoting trencher boom 102 at the second end 15, an undercarriage 104 intermediate the work machine, and a vehicle chassis 105. As shown, the operator station 100 is a cabin 19 on the work machine 12 and controls functions of the work machine. Alternatively, the operator station 100 may be located on, beside, or at a location remote from the work machine. The trencher boom 102 is configured to dig a trench when in a lowered position and to be clear of the ground when in a raised position. The trencher boom 102 is raised and lowered by one or more boom cylinders 103. A rotating digging chain (not shown) uncovers a trench by removing soil and depositing it proximate the work machine 12. The undercarriage 104 may comprise a wheeled or tracked motive force means for translating the work machine 12 across the ground. As shown, the undercarriage 104 comprises tracks 108 and is supported on an underside of the chassis 105. Operation of the tracks 108, boom cylinder 103 and digging chain (not shown) may be powered by a power pack 110, such as a combustion engine, supported by the chassis 105.

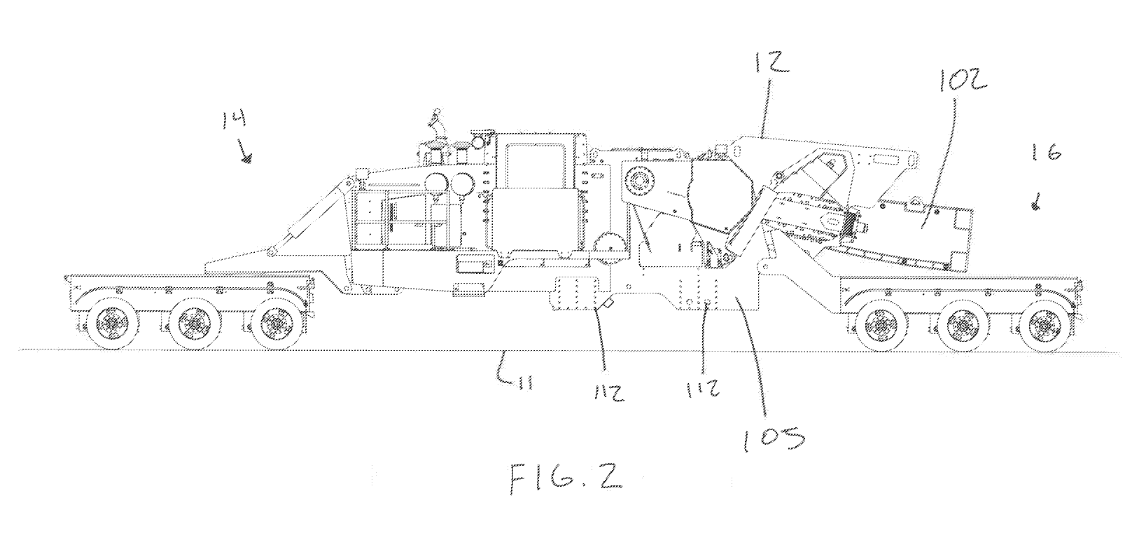

With reference to FIG. 2, the undercarriage 104 of FIG. 1 may be removed. The work machine 12 comprises undercarriage connection points 112. One of skill in the art will appreciate that removing the undercarriage allows the work machine 12 to have a lower weight, for easier maintenance on the undercarriage and chassis 105. The trencher boom 102 may also be removed to reduce weight, making the transport easier. As shown, the trencher boom 102 is connected in FIG. 2.

With reference to FIGS. 1-5, the various features of the kingpin assembly 14 and dolly assembly 16 are shown in detail. The kingpin assembly 14 comprises a kingpin 20, a kingpin plate 22, a kingpin plate actuator 24, and a kingpin shim 26. The king pin plate has a first end 28 and a second end 29. The kingpin plate 22 supports the kingpin 20 on an underside of the kingpin plate proximate the first end 28. The kingpin 20 is typically a cylindrical steel pin. Preferably, the kingpin 20 may be a 2 or 3.5 inch diameter pin, as is typically used to provide a connection to a fixed fifth wheel 51 of a towing vehicle 50. It should be appreciated that the tow vehicle 50 is only partially shown to illustrate the support of the work vehicle 12. While the kingpin 20 may be contemplated for attachments to the fifth wheel 51 of a tow vehicle 50, other connections to a tow vehicle may be contemplated, such as a traditional hitch, or connection to a jeep or other distributed set of axles which, in turn, is connected to the fifth wheel or other tow mechanism of a tow vehicle 50.

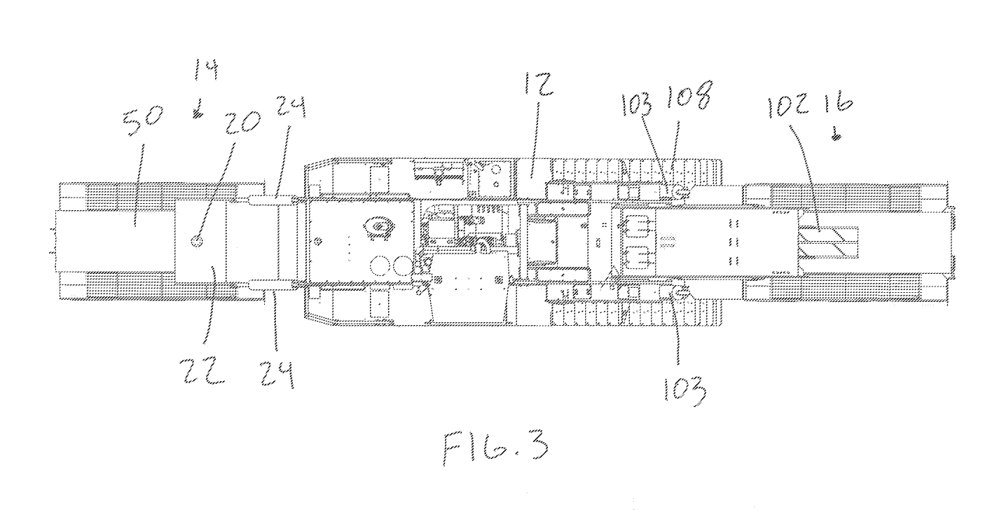

The kingpin plate 22 is connected at the second end 29 to the first end 18 of the work machine 12. The kingpin plate 22 may be connected by bolts, pins, or any other suitable connection. Preferably, the kingpin plate 22 pivots relative to the work machine 12. The kingpin plate 22 may pivot about a pivot pin 30 at the second end 29 of the kingpin plate. The kingpin plate 22 is attached to the kingpin plate actuator 24 intermediate the first 28 and second 29 ends. The kingpin plate actuator 24 may comprise one or more linear actuators. Such linear actuators may comprise hydraulic cylinders, screwjacks, or other mechanisms for pivoting the kingpin plate 22 about pin 30. As shown in FIG. 3, the kingpin plate actuator 24 comprises two hydraulic cylinders. During towing operations, the kingpin plate actuator 24 is set to a first position, wherein the kingpin 20 is substantially vertical to cause the optimum connection between the kingpin 20 and tow vehicle 50. One of skill may appreciate that the kingpin plate actuator 24 may be utilized during work machine 12 operation to provide a counterbalance for the trencher boom 102 when it is raised and lowered. Further, raising the kingpin plate 22 during operation may provide noise reduction due to its placement proximate the power pack 110.

The kingpin assembly 14 may be locked into place by the kingpin shim 26. The kingpin shim 26 may comprise any brace mechanism for preventing the relative movement of the kingpin assembly 14 relative to the work machine 12, to prevent unwanted movement during towing.

The dolly assembly 16 comprises a dolly connection plate 40, a frame 42, an air suspension system 43, and a plurality of wheels 44. As shown, there are three pair of wheels 44 each connected by an axle 46. The dolly connection plate 40 preferably attaches in one or more places to the chassis 105 of the work machine 12, though it could alternatively be connected to the trencher boom 102. The dolly connection plate 40 is connected to the chassis 105 by pins 48 and locked into position by one or more dolly shims 45. The dolly connection plate 40 may also be connected to the undercarriage 104. One of skill in the art will appreciate that in order to connect the dolly connection plate 40 to the trencher boom 102, the trencher boom is secured to the chassis 105 and not pivoting through its full range of motion.

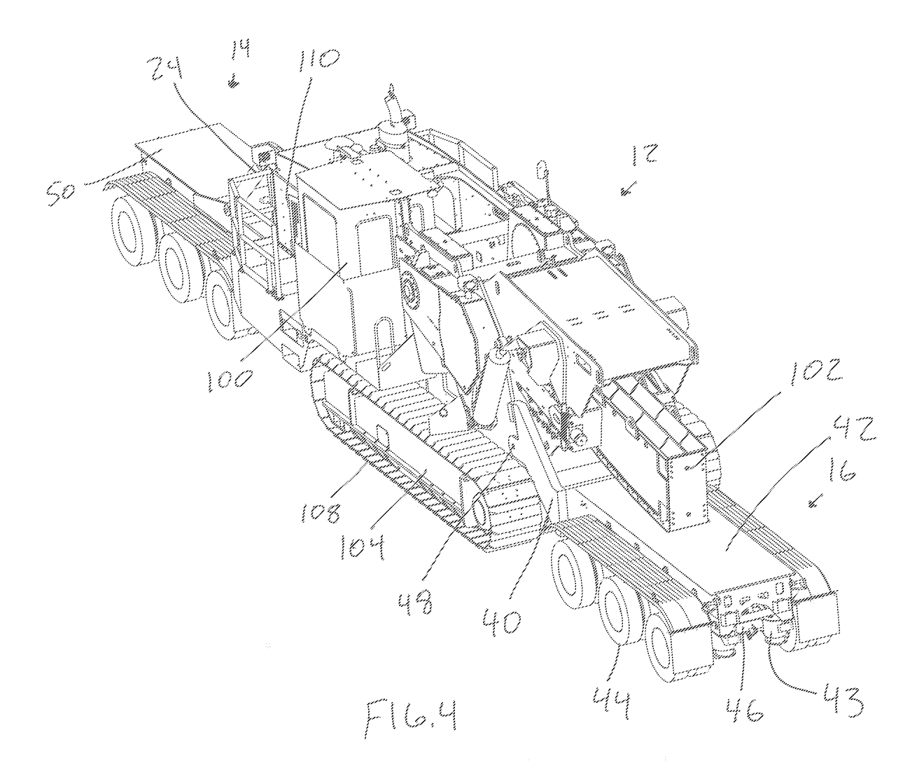

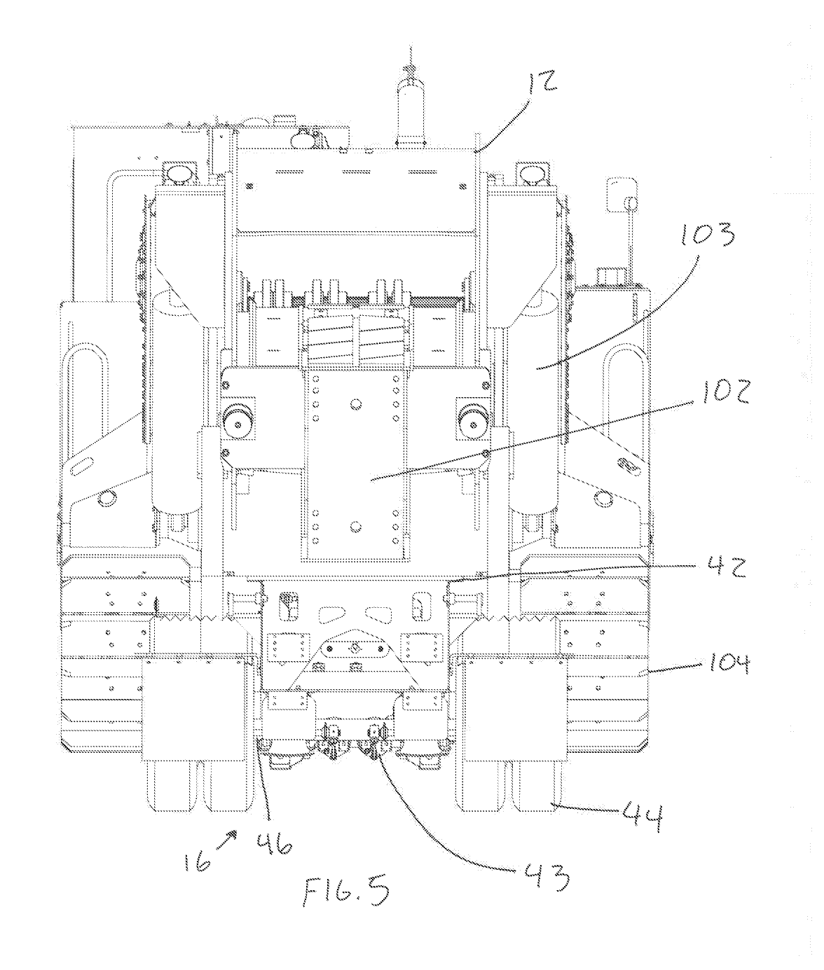

As shown in FIG. 4-5, the dolly assembly 16 may be able to raise or lower the work machine 12 relative to the ground using the suspension system 43 to clear obstacles such as railroad tracks. The air suspension system 43 may raise the entire frame 42 relative to the wheels 44, or may simply raise the dolly connection plate 40 relative to the frame to gain clearance under the undercarriage 104 of the work machine Thus, the air suspension system 43 may be used in conjunction with the tow vehicle 50 to raise and lower the work machine 12 relative to the ground 11, or to provide ground clearance for servicing the machine or removing the undercarriage 104. The air suspension system 43 may be independently powered on the dolly assembly 16, or may hydraulically connect to the power pack 110 of the work machine 12. The air suspension system 43 may be coordinated with an air suspension associated with the tow vehicle 50 or the kingpin plate actuator 24 to raise and lower the work machine 12.

The dolly assembly 16 may have more axles 46 for larger machines, or may have a stinger axle (not shown) attached to the frame 42 to essentially extend the wheel 44 base of the dolly assembly 16. The wheels 44 may be steerable or may have fixed axles 46.

In operation, the work machine 12 may drive up on blocks using the tracks 108 attached to its undercarriage 104, allowing the dolly assembly 16 to be attached to the chassis 105 or undercarriage. Alternatively, the dolly assembly 16 may be pinned to the chassis 105 and the trencher boom 102 may be lowered onto the dolly assembly. This causes the second end 15 of the work machine 12 to rise, enabling the dolly shims 48 to be installed. The dolly assembly 16 is preferably connectible to the fifth wheel of a tow vehicle 50 as well, such that the dolly assembly 16 can be towed to a work site when the work machine 12 is not installed. Alternatively, the kingpin assembly 14 may comprise a dolly assembly 16 connection point (not shown) such that the entire system 10 can be towed.

Various modifications can be made in the design and operation of the present invention without departing from its spirit. Thus, while the preferred construction and modes of operation of the invention have been explained in what is now considered to represent its best embodiments, it should be understood that within the scope of the appended claims, the invention may be practiced otherwise than as specifically illustrated and described.

What is claimed is:

1. A system for towing a vehicle, wherein the vehicle comprises a first end and a second end, the system comprising:
a kingpin disposed at the first end of the vehicle;
a dolly disposed at the second end of the vehicle; and
a hydraulic system for adjusting a height of the vehicle relative to the ground.

2. The system of claim 1 wherein the hydraulic system comprises a hydraulic cylinder for adjusting the kingpin.

3. The system of claim 1 wherein the hydraulic system comprises an air suspension system disposed on the dolly.

4. The system of claim 3 wherein the hydraulic system further comprises a hydraulic cylinder for adjusting the kingpin.

5. The system of claim 1 wherein the vehicle comprises a trencher boom located proximate the second end and capable of contacting the dolly, wherein the hydraulic system comprises a cylinder for adjusting the trencher boom.

6. The system of claim 1 wherein dolly comprises three sets of wheels.

7. The system of claim 6 wherein at least one of the three sets of wheels is steerable.

8. The system of claim 1 further comprising a kingpin plate, wherein the kingpin plate supports the kingpin and is attachable to the vehicle.

9. A trencher transport comprising:
a tow vehicle, the tow vehicle comprising a fixed fifth wheel; and
the system of claim 1 wherein the kingpin is connectable to the fixed fifth wheel.

10. A method for removing an undercarriage of a work vehicle comprising:
providing a kingpin assembly to a first end of the work vehicle;
attaching a dolly to a second end of the work vehicle;
attaching the kingpin assembly to a fixed fifth wheel of a tow vehicle;
raising a level of the work vehicle by manipulating the kingpin relative to the undercarriage and manipulating the dolly relative to the undercarriage; and
detaching the undercarriage from the work vehicle.

11. The method of claim 10 wherein the level of the dolly is manipulated relative to the undercarriage by contacting the dolly with a trencher boom attached to the work vehicle.

12. The method of claim 10 further comprising driving the work vehicle onto blocks prior to attaching the dolly to the second end of the work vehicle.

13. The method of claim 10 further comprising towing the work vehicle with the tow vehicle.

14. The method of claim 10 wherein the kingpin is manipulated with a hydraulic cylinder.

15. The method of claim 14 wherein the dolly is manipulated relative to the undercarriage by an air suspension system.

16. The method of claim 15 wherein the air suspension system and the hydraulic cylinder are in hydraulic communication.
